(19) United States
(12) Patent Application Publication
(10) Pub. No.: US 2015/0290668 A1
(43) Pub. Date: Oct. 15, 2015

(54) Paint brush Light and Methods

(71) Applicant: Jon Terry Cox, Riverton, WY (US)

(72) Inventor: Jon Terry Cox, Riverton, WY (US)

(21) Appl. No.: 14/252,774

(22) Filed: Apr. 14, 2014

(51) Int. Cl. B05C 1/06; F21V 23/04; F21V 33/00; B05C 11/00; F21L 4/02

(52) U.S. Cl. CPC B05C 1/06; B05C 11/00; F21L 4/02; F21V 33/0084; F21V 23/0414

(57) ABSTRACT

A light device for a paint brush includes an attachment bracket sized and shaped to attach to a ferrule of a paint brush. At least source one light is coupled to the bracket and oriented to project a light onto a surface being painted by the brush. A power source is coupled to the bracket and electrically coupled to the light source. A switch is coupled to the bracket and electrically coupled to the light source and the power source. The switch is configured to switch the light source on and off.

### PRIORITY CLAIM

This patent application claims benefit of U.S. Provisional Patent Application No. 61/811,125, filed on Apr. 12, 2013, which is incorporated by reference in its entirety for all purposes.

### BACKGROUND OF THE INVENTION

1. Field of the Invention

The present invention relates generally to paint brushes and more particularly to a light system attachable to the paint brush.

2. Related Art

Painting is often done in less than optimum lighting conditions. This is especially true in the corners of rooms where two walls meet at an oblique angle. Such intersections are often only paintable if the painter places himself between the corner of the wall and the light source of the room, thereby casting shadows over the area being painted. Shadows make it difficult to see if an even layer of paint is being applied during application of the paint.

### SUMMARY OF THE INVENTION

The inventor of the present invention has recognized that it would be advantageous to develop a light system that can be attached to a paint brush to provide light to an area being painted by the paint brush. Additionally, the inventor of the present invention has recognized that it would be advantageous to develop a hands free method for lighting a surface being painted.

Accordingly, the invention provides a light device for a paint brush including an attachment bracket sized and shaped to attach to a ferrule of a paint brush. At least source one light can be coupled to the bracket and oriented to project a light onto a surface being painted by the brush. A power source can be coupled to the bracket and electrically coupled to the light source. A switch can be coupled to the bracket and electrically coupled to the light source and the power source. The switch can be configured to switch the light source on and off.

The present invention also provides for a method for lighting a surface to be painted including coupling a bracket of a light device to a ferrule of a paint brush. A light source on the bracket can be oriented on the paint brush to project a light beam parallel to the bristles of the paint brush. The light source can be activated by pressing a switch on the attachment bracket to turn on the light source in order to illuminate the area of the surface immediately adjacent bristles.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is perspective view of a light device coupleable to a paint brush in accordance with an embodiment of the present invention;

FIG. 2 is a side view of the light device of FIG. 1;

FIG. 3 is a front view of the light device of FIG. 1;

FIG. 4 is a rear view of the light device of FIG. 1; and

FIG. 5 is a top view of the light device of FIG. 1.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

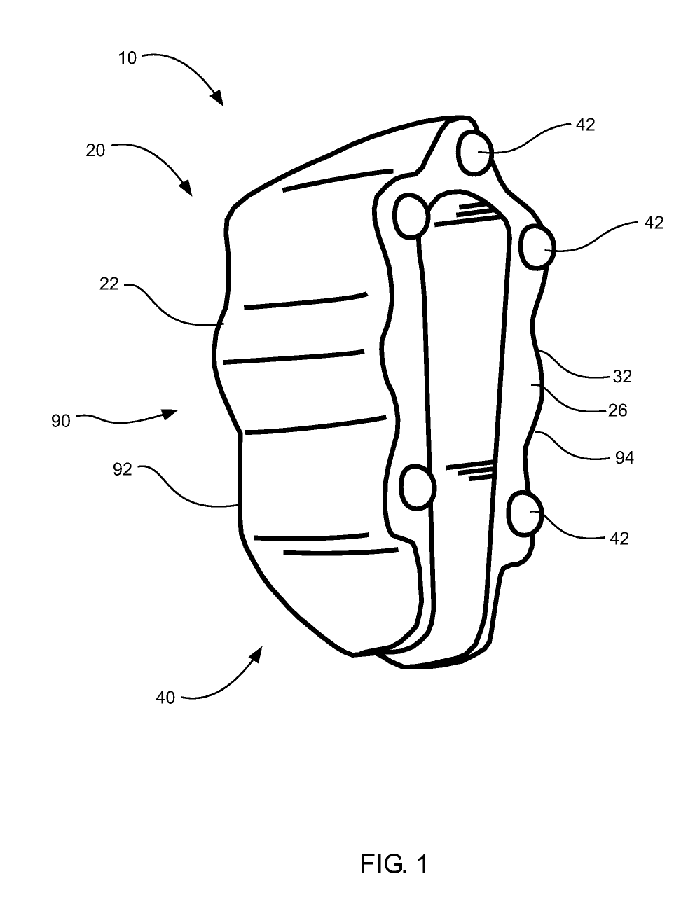

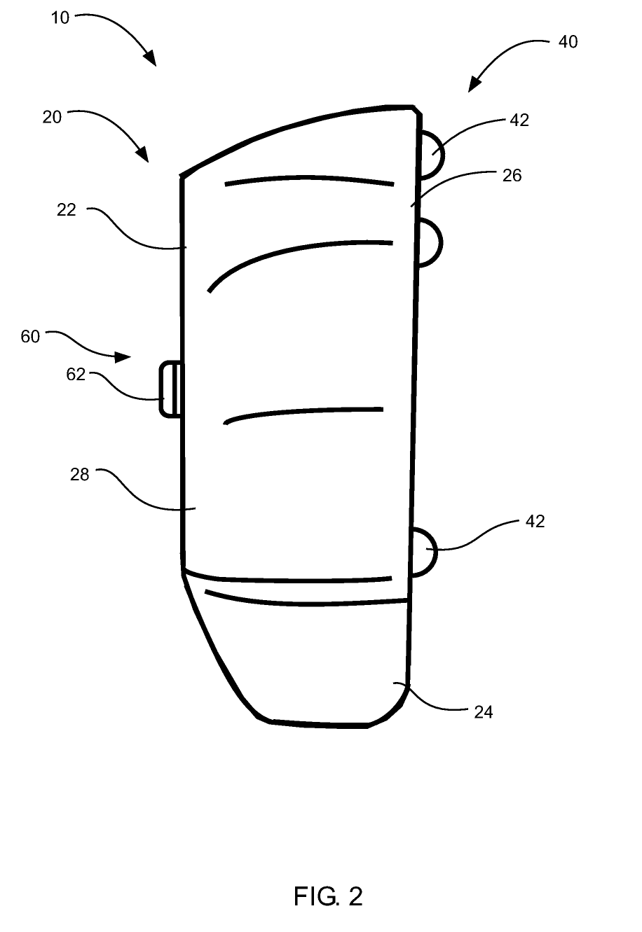

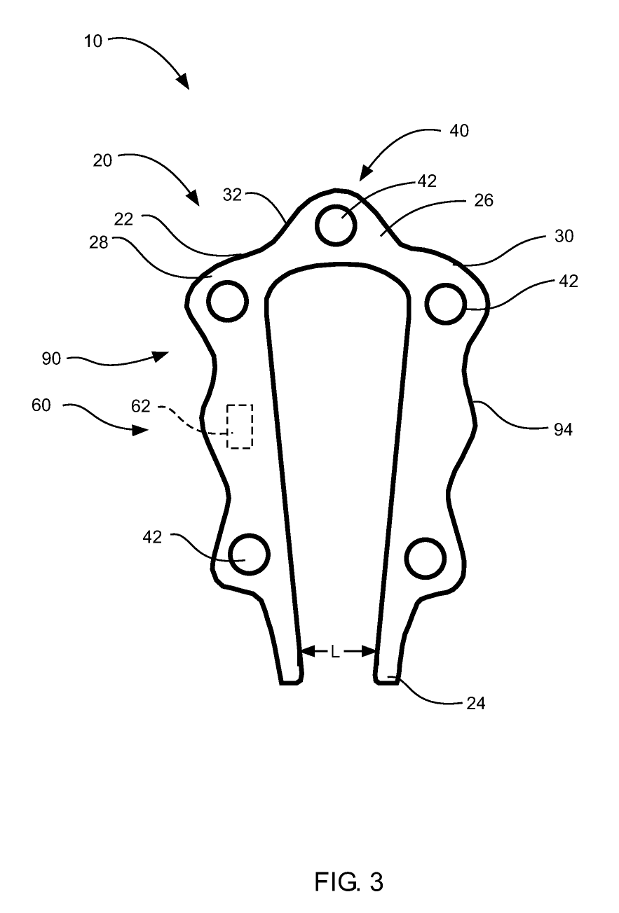

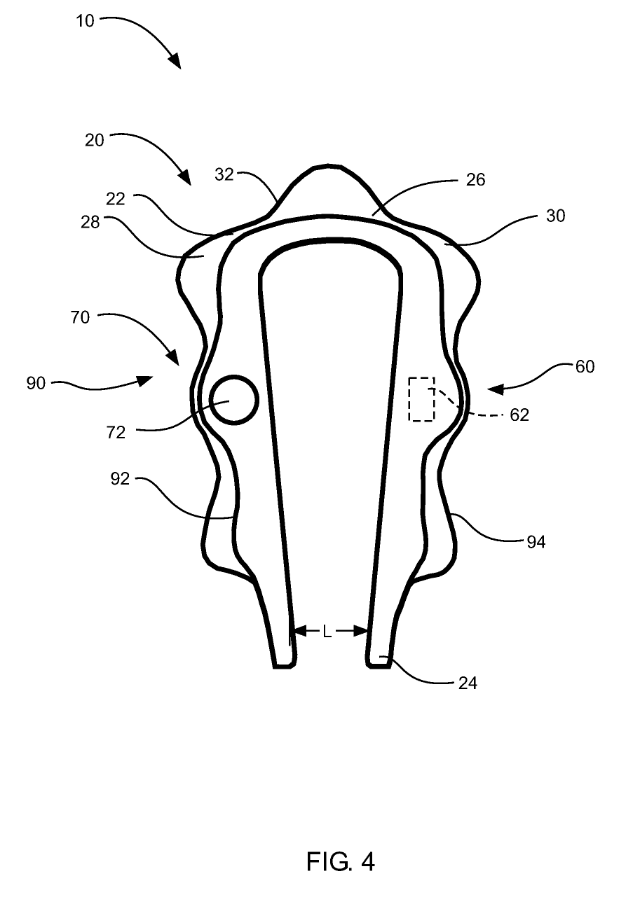

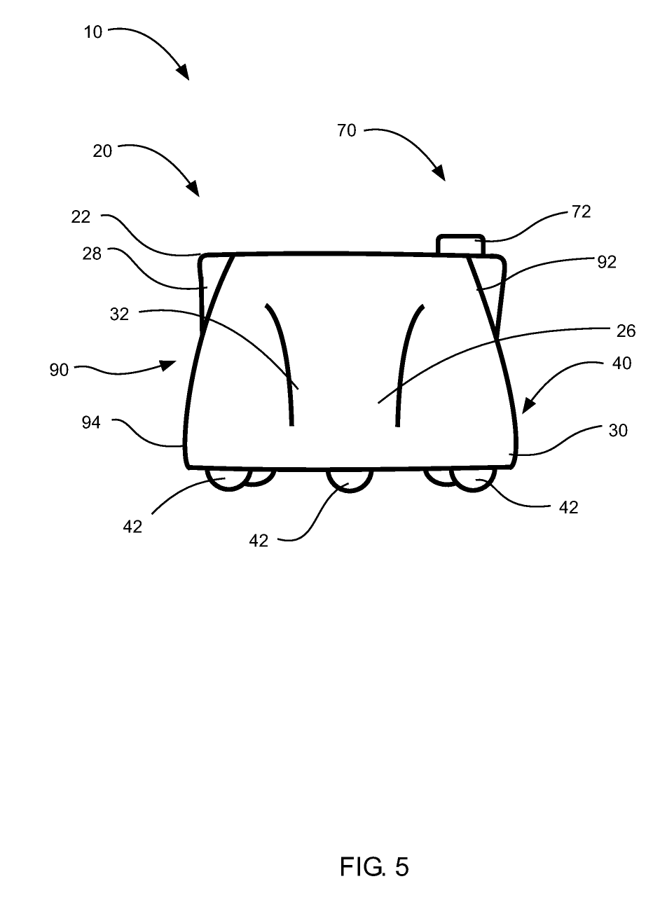

As illustrated in FIGS. 1-5, a light device, indicated generally at 10, is shown in accordance with an embodiment of the present invention. The light device can be attached to a paint brush to provide light to a surface being painted. The light device includes an attachment bracket, indicated generally at 20, at least one light source, indicated generally at 40, a power source 60, and a switch 70.

The attachment bracket 20 can be sized and shaped to attach to a ferrule or handle of a paint brush. As shown in the FIGs., the attachment bracket can be a U-shaped clamp 22 configured to clamp onto the ferrule or handle of a paint brush (not shown). In one aspect, the attachment bracket can be formed of a metal material such as aluminum. In another aspect the attachment bracket can be formed of a plastic material. The attachment bracket can be coated with an elastomeric type material such as rubber.

The U-shaped clamp 22 can have an open end 24 and a closed end 26. The U-shaped clamp can be formed from two longer side pieces 28, 30 and a shorter end piece 32. The end piece can join the two longer side pieces and form the closed end 26 of the clamp. The two sides 28 and 30 can be angled toward one another such that the sides on the open end are relatively closer together than the sides at the closed end.

The two sides 28 and 30 can be flexible or spring-like such that the sides can move or flex with respect to one another to yield a smaller or larger opening, as desired, on the open end 24. The sides 28 and 30 at the open end 24 can be biased to a set distance L from one another such that the sides will return or spring back to the set distance when the bracket is in a free or unattached state. The sides can be moved from the set distance L when the bracket 20 is placed over the ferrule or handle of a paint brush and the bias or spring-like tendency of the sides to return to the set distance can act as a clamp to hold the bracket onto the paint brush ferrule or handle. In this way, the bracket can be flexible to fit a variety of differently sized ferrules.

The light source 40 can be coupled to the bracket 20 and oriented to project a light beam onto a surface being painted by the paint brush. In one aspect, the light source 40 can be an LED lamp 42 that can be directed to shine at a wide angle in a desired direction, such as parallel to the bristles of the paint brush. As shown in the FIGs., the light device 10 can have at least one light source on each of the three sides of the bracket. The light source, or a portion thereof, can be coated along with the attachment bracket with an elastomeric coating such as rubber.

The power source 60 can be coupled to the bracket 20 and electrically coupled to the light source 40. The power source 60 can be a battery 62 having a low or slim profile so as not to protrude into the hand of the painter when holding the paint brush. In this way, the battery 62 can have a low profile to minimize interference with a user's hand when holding the paint brush. The battery can be coated along with the attachment bracket with an elastomeric coating such as rubber.

The switch 70 can be coupled to the bracket 20 and electrically coupled to the light source 40 and the power source 60. The switch 70 can be a pop switch, toggle switch, button switch 72, or the like and can be configured to turn the light source on and off. In one aspect, the switch can have a plurality of switch positions that turn on or off one or more or all of the light sources on the bracket. In another aspect, the switch can have a simple on or off function to turn all of the light sources either on or off.

The switch 70 can be sized shaped and positioned on the bracket to allow operation of the switch by the same hand of a user's hand that is holding the paint brush. In this way, the light device 10 and paint brush can be operated by a single hand of the user thereby freeing up the other hand of the user for other purposes, such as holding a can of paint.

The switch 70 can also have a low or slim profile so as not to protrude into the hand of the painter when holding the paint brush. Hence, the switch 70 can reduce or minimize interference with a user's hand when holding the paint brush. The switch can be also coated along with the attachment bracket with an elastomeric coating such as rubber.

Additionally, the light device 10 can be ergonomically shaped to facilitate use of the paint brush by a user's hand when the light device is coupled to the paint brush. For example, as best seen in FIGS. 1, 3 and 4, the body of the light device can have a contour, shown generally at 90, that can facilitate positioning of the users fingers on the paint brush. Advantageously, the contours can be shaped to aid a user in correctly grasping the brush in the least fatiguing and most controlling manner. Additionally, the contours can be shaped with a smaller profile 92 near the user's palm and a larger profile 94 near the user's fingertips.

The present invention also provides for a method for lighting a surface to be painted including coupling a bracket of a light device to a ferrule of a paint brush. A light source on the bracket can be oriented on the paint brush to project a light beam parallel to the bristles of the paint brush. The light source can be activated by pressing a switch on the attachment bracket to turn on the light source in order to illuminate the area of the surface immediately adjacent bristles.

The present invention also provides for a method for using a paintbrush including coupling a bracket of a light device to a ferrule of a paint brush. The handle of the paintbrush can be grasped in a user's hand. Fingers of the user can be positioned to fit within a contoured profile of the light device such that the user's hand and fingers can be guided into an optimal position for grasping a paintbrush. A thumb of the user can access and operate a switch on the light device to activate a light that illuminates a surface to be painted.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A light device for a paint brush, comprising:
a) an attachment bracket sized and shaped to attach to a ferrule of a paint brush;
b) at least source one light coupled to the bracket and oriented to project a light onto a surface being painted by the brush;
c) a power source coupled to the bracket and electrically coupled to the light source; and
d) a switch coupled to the bracket and electrically coupled to the light source and the power source, the switch being configured to switch the light source on and off.

2. The device of claim 1, wherein the bracket is a U-shaped clamp configured to clamp onto a ferrule of a paint brush.

3. The device of claim 1, wherein the bracket has three sides with a light source on each of the three sides.

4. The device of claim 1, wherein the bracket is flexible and flexes to fit a variety of differently sized ferrules.

5. The device of claim 1, wherein the light source is configured to produce a wide angled light beam.

6. The device of claim 1, wherein the power source is a battery and has a low profile when coupled to the bracket to minimize interference with a user's hand when holding the paint brush.

7. The device of claim 1, wherein the bracket is sized and shaped to minimize interference with a user's hand when holding the paint brush.

8. The device of claim 1, wherein the switch is sized shaped and positioned on the bracket to allow operation of the switch by a user's hand when holding the paint brush.

9. The device of claim 1, wherein the light device is ergonomically shaped to facilitate use of the paint brush by a user's hand when the light device is coupled to the paint brush.

10. The device of claim 1, wherein the device has a contoured profile shaped to guide the user's hand and fingers into an optimal position for grasping a paintbrush.

11. The device of claim 10, wherein the contoured profile is smaller at a rearward portion and larger at a forward portion.

12. A method for lighting a surface to be painted, comprising:
a) coupling a light source to a ferrule of a paint brush;
b) orienting the light source to project a light beam parallel to the paint brushes bristles; and
c) activating the light source to illuminate the area of the surface immediately adjacent bristles.

13. A paint brush, comprising:
a) a handle with a grip end and a brush attachment end;
b) a plurality of bristles together forming a brush and coupled to the brush attachment end of the handle;
c) a ferrule circumscribing and joining the brush attachment end of the handle and the brush;
d) an attachment bracket removably coupleable to the ferrule; and
b) at least source one light coupled to the bracket and oriented to project a light onto a surface being painted by the brush.

14. A paint brush in accordance with claim 11, further comprising:
a) a power source coupled to the bracket and electrically coupled to the light source; and
b) a switch coupled to the bracket and electrically coupled to the light source and the power source, the switch being configured to switch the light source on and off.
